(19) United States
(12) Patent Application Publication
(10) Pub. No.: US 2005/0100052 A1
(43) Pub. Date: May 12, 2005

(54) Method and apparatus for receiver processing in a CDMA communications system

(76) Inventors: Laurence E. Mailaender, New York, NY (US); John G. Proakis, Andover, MA (US)

Correspondence Address: HARNESS, DICKEY & PIERCE, P.L.C., P.O. Box 8910, Reston, VA, 20195, US

(21) Appl. No.: 10/703,500

(22) Filed: Nov. 10, 2003

(51) Int. Cl. H04J 13/00

(52) U.S. Cl. 370/479; 370/441

(57) ABSTRACT

In the method and apparatus for receiver processing of CDMA signals, linear equalization of at least one received signal is followed by non-linear symbol estimation of each symbol stream in the received signal. An approximation of the original received signal formed from the estimated symbol streams is then filtered. The output from this filtering is combined with output from filtering of the received signal to produce the receiver processed received signal.

### BACKGROUND OF THE INVENTION

In CDMA cellular systems such as UMTS, user data is transmitted using multiple orthogonal codes. For example, user data from K sources, bₖ, are assigned spreading sequences, sₖ, and are transmitted as a composite signal over a dispersive channel, h (e.g., an air interface). Such a time-dispersive multipath channel spanning a single chip or more causes two distinct types of degradation: code-to-code interference due to loss of orthogonality among the codes (MAI), as well as ordinary intersymbol interference (ISI). The impact of ISI can be significant in high-speed data transmissions such as HSDPA where the number of chips per symbol is only 16.

Both of the above-described degradations can be handled by chip-level linear equalization at the receiver. The linear equalizer precedes a despreading operation for each source. A remarkable property of the chip-level equalizer is that only a single equalizer is needed to correct all the spreading codes. To further improve system capacity, it would be desirable to use decision-feedback equalization at the chip level. However, as the chip SNR is extremely low, and the composite signal has an extremely large constellation, decisions on individual chips are unreliable. To overcome this, it has been previously proposed to use hypothesis-feedback, in which several equalizers are run in parallel, each conditioned on a possible data symbol hypothesis. While this can be very effective for reducing the ISI of a single user, it is extremely complex if all the hypotheses for all K users are included, as would be necessary in the downlink. For example, in a QPSK system with 16 spreading codes, there are 4¹⁶=4.3×10⁹ possible hypotheses.

### SUMMARY OF THE INVENTION

In the method and apparatus for receiver processing of CDMA signals, linear equalization of at least one received signal is followed by non-linear symbol estimation of each symbol stream in the received signal. In an exemplary embodiment, the linear equalization takes place at the chip level of the received signal (e.g., prior to despreading), and the symbol estimation take place at the symbol level of the received signal (e.g., after despreading). An approximation of the original received signal formed from the estimated symbol streams is then filtered. In an embodiment of the present invention, this filtering takes place at the chip level of the received signal, and the output from this filtering represents the influence of at least one of past and future chips on a current chip of the received signal. The output from this filtering is combined with output from filtering of the received signal to produce the equalized received signal.

As will be described in detail with respect to the embodiments of the present invention, the present invention is applicable to single input, single output (SISO) communication systems; multiple input, multiple output (MIMO or BLAST) communication systems, transmit diversity communication systems, etc.

### BRIEF DESCRIPTION OF EXEMPLARY EMBODIMENTS

The present invention will become more fully understood from the detailed description given herein below and the accompanying drawings which are given by way of illustration only, wherein like reference numerals designate corresponding parts in the various drawings, and wherein:

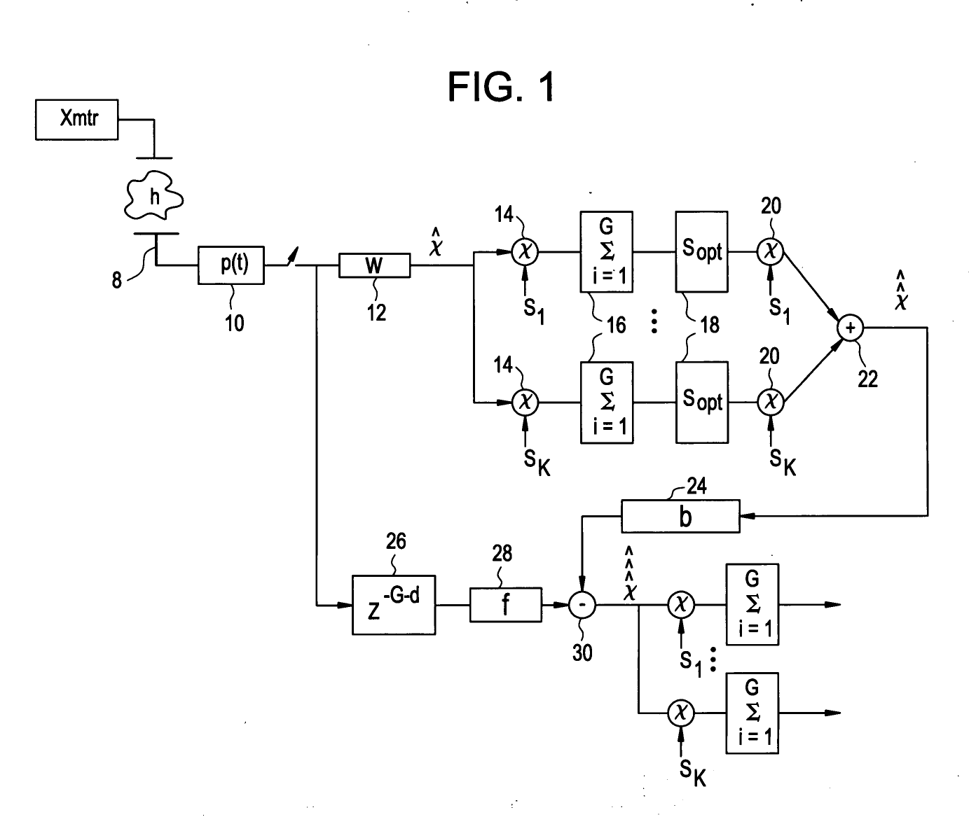

FIG. 1 illustrates an exemplary embodiment of an apparatus for receiver processing according to the present invention;

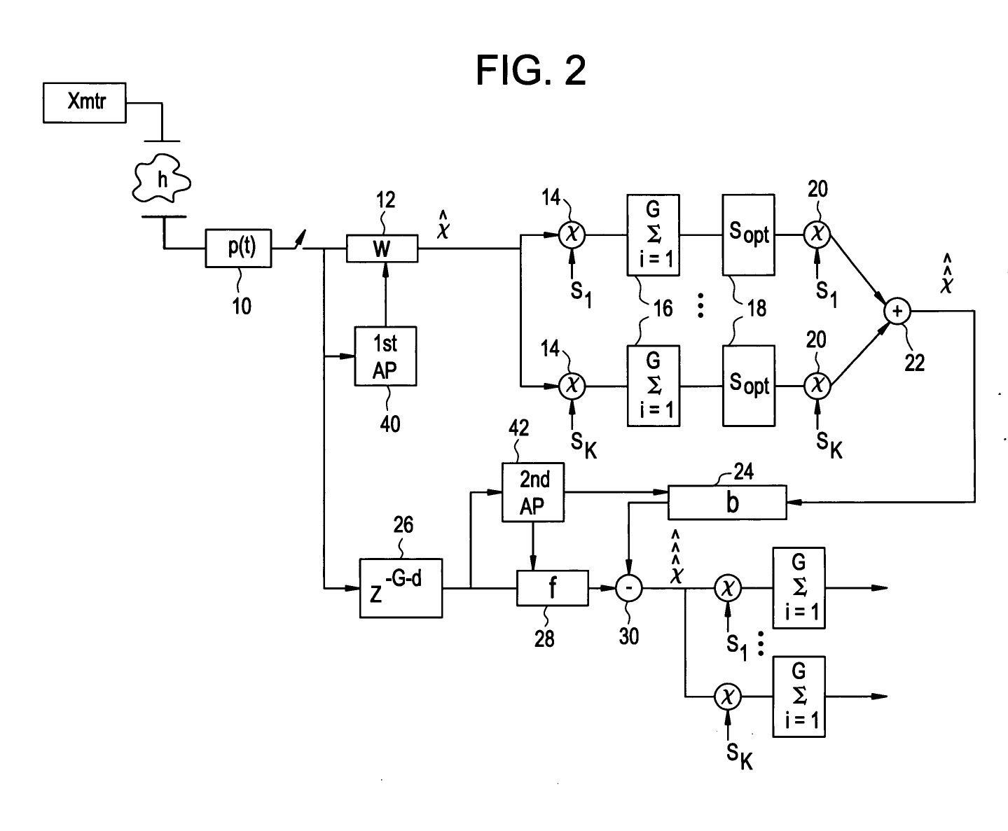

FIG. 2 illustrates another embodiment of the present invention in which filter taps are adaptively determined;

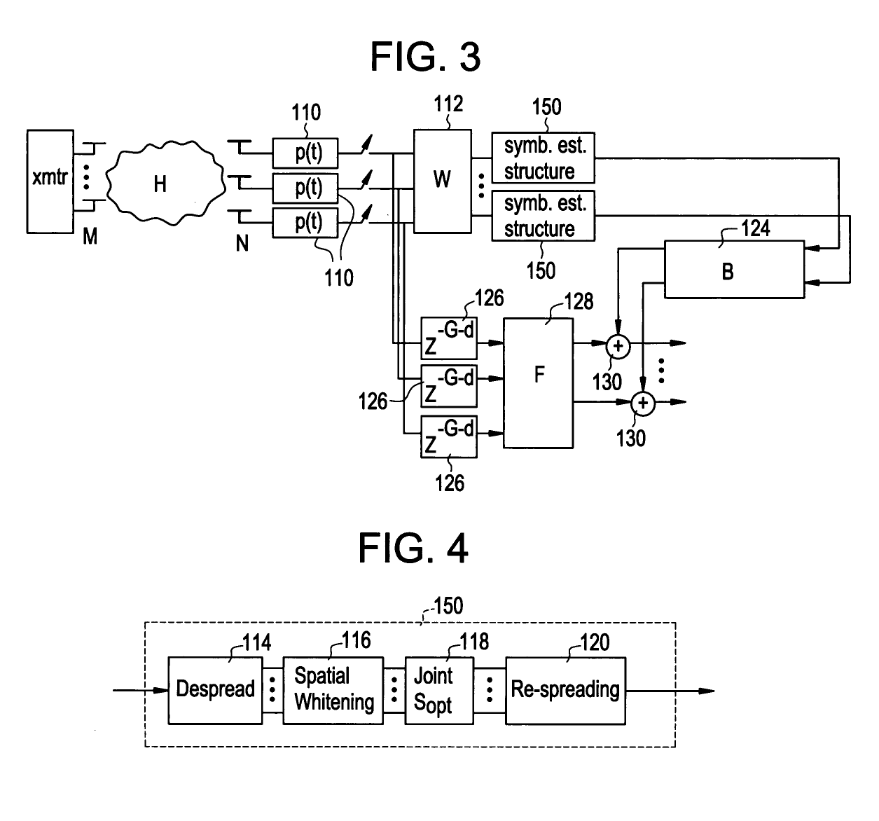

FIG. 3 illustrates an embodiment of a MIMO system according to the present invention;

FIG. 4 illustrates an embodiment of the symbol estimation structure in the embodiment of FIG. 3; and

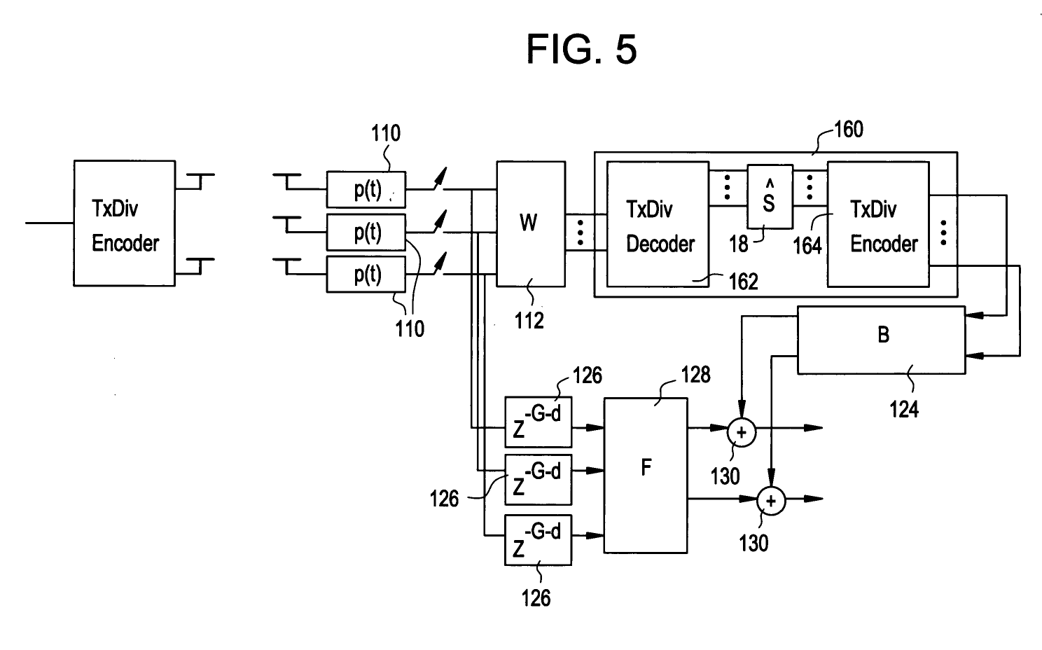

FIG. 5 illustrates an embodiment of the receiver processing structure according to the present invention for a transmit diversity system.

### DETAILED DESCRIPTION OF EXEMPLARY EMBODIMENTS

FIG. 1 illustrates an exemplary embodiment of an apparatus for receiver processing according to the present invention. As shown, a sampler 10 samples the chips of a signal received by an antenna 8 to generate a received signal. In one exemplary embodiment, the sampler 10 oversamples the chips such that at least two samples per chip are obtained. A linear equalizer 12 processes the received signal to produce a linear equalized signal. The linear equalization performed by the linear equalizer is conducted according to any well-known linear equalization algorithm. The linear equalized signal is despread by mixing the linear equalized signal with the respective spreading codes s₁, . . . , sₖ at mixers 14. Accumulators 16 associated with the mixers 14 accumulate the despread chips produced by the mixers 14. A symbol estimator 18 associated with each accumulator 16 performs a non-linear, soft-estimation of symbols in the output stream from the accumulator 16. For example, each symbol estimator 18 is an optimal conditional-mean estimator that obtains soft estimates of the individual symbols. The estimated symbol streams are respread by mixers 20 and combined at an adder 22 to produce an approximation \hat{\hat{x}} of the original chip sequence \hat{x}. This sequence of “correct” chip decisions is used as the input to a feedback filter 24.

As will be described in detail below, the feedback filter 24 generates an output representing the influence past and future chips have on a current chip in the received signal. A delay 26 delays the received signal, and a feedforward filter 28 filters the received signal. In an exemplary embodiment, the delay 26 delays the received signal by an amount of time to generate the linear equalization signal and despread, detect and respread the linear equalization signal. This allows the symbol estimators 18 to make symbol decisions based on future chips and the feedback filter 24 may generate an output representing the influence past and future chips have on a current chip in the received signal output by the feedforward filter 28. As will be appreciated, the embodiment of the present invention may be arranged such that the feedback filter 24 produces output representing the influence of only past chips on a current chip. A second combiner 30 subtracts the output of the feedback filter 24 from the output of the feedforward filter 28 to produce estimates of the current chips in the received signal with the detrimental influence of past and future chips suppressed and/or removed. The processed received signal output from the second combiner 30 may then be spread and accumulated as shown in FIG. 1 to produce the individual symbol streams. As will be described in detail below, the feedback filter 24 and the feedforward filter 28 are co-generated using a process resembling decision-feedback-equalization.

Let FF denote the number of chips in the feedforward filter 28, FB the number in the feedback filter 24, and P the over-sampling factor of the sampler 10. The vector of received samples contained in the feedforward filter is,

$$\begin{matrix}\begin{matrix}[ \begin{matrix}{r}_{p} ( k ) \\ {r}_{p} ( k - 1 ) \\ ⋮ \\ \\ {r}_{p} ( k - FF + 1 )\end{matrix} ] = [ \begin{matrix}{h}_{0} & {h}_{1} & ⋯ & {h}_{L - 1} & 0 & ⋯ & 0 \\ 0 & {h}_{0} & {h}_{1} & ⋯ & {h}_{L - 1} & ⋯ & 0 \\ & ⋰ & ⋰ & ⋰ & & & \\ & & ⋰ & ⋰ & ⋰ & & \\ 0 & ⋯ & 0 & {h}_{0} & {h}_{1} & ⋯ & {h}_{L - 1}\end{matrix} ] \\ [ \begin{matrix}x ( k ) \\ x ( k - 1 ) \\ ⋮ \\ ⋮ \\ x ( k - FF - L + 2 )\end{matrix} ] + \\ [ \begin{matrix}{n}_{p} ( k ) \\ {n}_{p} ( k - 1 ) \\ ⋮ \\ ⋮ \\ {n}_{p} ( k - FF - L + 2 )\end{matrix} ] or ,\end{matrix} & ( 0.1 ) \\ {r}_{k} = Γ ( h ) {x}_{k} + {n}_{k} & ( 0.2 )\end{matrix}$$

where rₖ is the vector of received samples, Γ(h) represents L echoes (multipath delay distortion) of a channel for each received sample, xₖ is the kth transmitted sample, and nₖ is the noise for sample k.

Let f(i) and b(i) denote the i-th feedforward and feedback tap, respectively. The estimate of the chip value at delay d is,

$$\begin{matrix}\hat{x} ( k - d ) = {\sum }_{i = 0}^{FF - 1} {f ( i )}^{T} r ( k - i ) - \\ {\sum }_{j = 1}^{FB} b ( j ) x ( k - d - j ) - \\ {\sum }_{q = 1}^{d} b ( - q ) x ( k - d + q )\end{matrix} \qquad ( 0.3 )$$

with terms corresponding to the feedforward, causal feedback and anti-causal feedback sections. The MMSE (Minimum Mean Squared Error) tap weights are found from the solution of,

$${c}_{opt} = arg {min}_{c} E \{ {‖ x ( k - d ) - {c}^{H} 𝓋 ‖}^{2} \} \qquad ( 0.4 )$$

where we define
cΔ[f₀^{H},f₁^{H}, . . . ,f_{FF-1}^{H},−b*_{-d},−b*₋₁,−b*_{FB}]^{T} (0.5)
vΔ[r(k), . . . ,r(k−FF+1),x(k), . . . ,x(k−d+1),x(k−d−1), . . . ,x(k−d−FB)]^{T} (0.6)
where c are the current or initial taps of the feedforward and feedback filters 24 and 28; and v is vector of the inputs to the feedforward and feedback filters 24 and 28.

The solution obtained via the Orthogonality Principle is,

$$\begin{matrix}{f [ Ω - \frac{1}{{σ}_{x}^{2}} {XX}^{H} ]}^{- 1} h & ( 0.7 ) \\ b = \frac{1}{{σ}_{x}^{2}} {X}^{H} f & ( 0.8 ) \\ X = {σ}_{x}^{2} [ \begin{matrix}{h}_{0} & {h}_{1} & ⋯ & {h}_{d - 1} & {h}_{d + !} & ⋯ & {h}_{d + FB} \\ 0 & {h}_{0} & & ⋮ & {h}_{d} & & {h}_{d + FB - 1} \\ ⋮ & ⋰ & ⋰ & ⋮ & ⋮ & & ⋮ \\ 0 & ⋯ & 0 & {h}_{0} & {h}_{d - FF + 2} & ⋯ & {h}_{d + FB - FF + 1}\end{matrix} ] & ( 0.9 ) \\ Ω = {σ}_{x}^{2} Γ ( h ) {Γ ( h )}^{H} + {σ}_{n}^{2} {R}_{p} & ( 1.10 )\end{matrix}$$

where σₓ is the signal power; σₙ is the noise power; h is the complex numbers representing the channel impulse response at delay L; and Rₚ is the covariance matrix of the received signal,
RₚΔE{rr^{H}} (0.10)
Each conditional-mean estimator 18 is,

$${\hat{s}}_{opt} = E \{ s \vert r \} = {\sum }_{∀ {s}_{i}}^{} s p ( {s}_{i} \vert r ) = {\sum }_{∀ {s}_{i}}^{} {d}_{i} \frac{p ( r \vert {s}_{i} ) Pr ( {s}_{i} )}{p ( r )} \qquad ( 1.11 )$$

where s is the symbol being estimated; ∀ₛ represents the alphabet of possible symbols; r is the output of the accumulator 16; and p(r/sᵢ) is the likelihood of r; and

$$p ( r ) = {\sum }_{{∀}_{si}}^{} p ( r / {s}_{i} ) .$$

Given the likelihood for the complex scalar r, the correlator output is,

$$p ( r \vert {s}_{i} ) = \frac{1}{{πσ}_{n}^{2}} exp ( - \vert r - {gs}_{i} {\vert}^{2} / {σ}_{n}^{2} ) \qquad ( 1.12 )$$

where g is a gain factor that depends on the linear equalizer gain. For example, in an exemplary embodiment, g is set equal to the spreading gain. For the case of QPSK with symbol alphabet dᵢ=(±1±j)/\sqrt{2} we find that the estimator is,

$${\hat{d}}_{opt} = \frac{1}{\sqrt{2}} tanh ( \sqrt{2} \frac{Re ( {g}^{*} r )}{{σ}_{n}^{2}} ) + \frac{j}{\sqrt{2}} tanh ( \sqrt{2} \frac{Im ( {g}^{*} r )}{{σ}_{n}^{2}} ) \qquad ( 1.13 )$$

Similar expressions may be found for the case of 8-PSK, 16-QAM, etc.

In one embodiment, a controller (not shown) at the receiver makes and receives measurements to produce the variables used in the above-described equations to generate the taps for the feedback filter 24, the taps for the feedforward filter 28, and to produce the variables used by estimators 18 in generating the symbol estimate sₒₚₜ. Because the variables in the equations above are well-known and the measurements required to produce these variables are well-known, these processes will not be described in detail. For example, the received signal is known when the transmitter sends pilot signals, and on this basis, the signal power, noise power, etc., may be derived.

FIG. 2 illustrates another embodiment of the present invention in which the taps of the linear equalizer 12 are determined by a first adaptive processor 40 and the taps of the feedforward filter 28 and feedback filter 24 are determined by a second adaptive processor 42. The first and second adaptive processors 40 and 42 use an adaptive algorithm to determine the tap weights, [w,f,b]. This may be done using the standard LMS (Least Mean Square), RLS (Recursive Least Squares), chip-level, symbol-level, etc. algorithms that are well-known in the art. For example, the taps of the feedforward and feedback filters 24 and 28 may be determined by LMS according to the following expression:
cₖ₊₁=cₖ+μvₖ(xₚᵢₗₒₜ(k−d)−cₖ^{H}v)*
As discussed above, the “reference” signal used for the adaptive algorithm may be CDMA pilot codes xₚᵢₗₒₜ, ordinary training symbols, or the CDMA pilot code(s) combined with partial knowledge of the traffic-bearing signals. If this partial knowledge is not used, then an additional correlator for the pilot channel is useful to eliminate noise from the error signal. Alternatively, so-called “blind” or “semi-blind”estimation algorithms may be used.

The above-described embodiments were directed to SISO (single input, single output) systems. However, the present invention is not limited to SISO systems, but is applicable to other types of systems such as MIMO (multiple input, multiple output) and transmit diversity systems.

FIG. 3 illustrates an embodiment of a MIMO system according to the present invention. The MIMO system is shown as having M transmit antennas and N receive antennas. The receiver processing structure shown in FIG. 3 is analogous to that of FIG. 1, except that because of the multiple multipath channels, the linear equalizer and filters in the MIMO system are matrix based.

Specifically, FIG. 3 shows samplers 110 each sampling the chips of a signal received by one the N receive antennas to generate a received signal. In one exemplary embodiment, the samplers 110 oversample the chips such that at least two samples per chip are obtained. A matrix linear equalizer 112 processes the received signals to produce linear equalized signals. The linear equalization performed by the matrix linear equalizer is conducted according to any well-known matrix linear equalization algorithm. The linear equalized signals are each received by a symbol estimation structure 150. FIG. 4 illustrates an embodiment of the symbol estimation structure. As shown, a despreader 114 despreads the linear equalized signal by mixing the linear equalized signal with the respective spreading codes s₁, . . . , sₖ using mixers. A spatial whitening unit 116 transforms the remaining interference and noise so that its spatial covariance is equal to the identity matrix in any well-known manner, such as disclosed in U.S. application Ser. No. 10/340,875, entitled METHOD AND APPARATUS FOR DETERMINING AN INVERSE SQUARE ROOT OF A GIVEN POSITIVE-DEFINITE HERMITIAN MATRIX, filed Jan. 10, 2003; the contents of which are hereby incorporated by reference in their entirety. A joint symbol estimator 118 performs a simultaneous non-linear, soft-estimation of M symbols in the output stream from the spectral whitening unit 116. For example, a near-maximum likelihood processing with hard or soft outputs, such as the sphere decoding algorithm, may be performed by the joint symbol estimator 118. Alternatively, the so-called “V-Blast” subtractive type process may be employed. The following is a further example of an estimation process performed by the joint symbol estimator 118 corresponding to the conditional-mean estimator for the vector of M symbols:

$$\begin{matrix}{\hat{s}}_{opt} = E \{ s \vert r \} \\ = {\sum }_{∀ {s}_{i} ∈ {C}^{M}}^{} s p ( {s}_{i} \vert r ) \\ = {\sum }_{∀ {s}_{i} ∈ {C}^{M}}^{} {s}_{i} \frac{p ( r \vert {s}_{i} ) Pr ( {s}_{i} )}{p ( r )}\end{matrix}$$

$$where , \\ p ( r \vert {s}_{i} ) = \frac{1}{{πσ}_{n}^{2}} exp ( - {‖ r - \hat{H} {s}_{i} ‖}^{2} / {σ}_{n}^{2} )$$

and where C^{M} represents an M-dimensional vector of possible constellation points.

The soft symbol values are then re-spread and contributions from the K codes are summed by the re-spreader 120. The result is an estimation of the chips transmitted by each of the M sources. These are now used in matrix feedback filter 124 in FIG. 3, which subtracts out same-antenna chip interference as well as other-antenna chip interference when the output thereof is combined with the output from the matrix feedforward filter 28 by adders 130. The matrix feedforward filter 128 again has a delayed input because of delays 126—one for each received signal. In one embodiment, a two-sided feedback filter 124 is used (to subtract past as well as future chips), while in another embodiment, the filter 124 is one-sided. The outputs from the adders 130 are then despread, and whitened detected for each spreading code.

The filters associated with this embodiment of the present invention are matrix filters, [W,F,B]. The matrix feedback and feedforward filters 124 and 128 can be computed as follows, where the estimate of a chip from the m-th transmitter is,

$$\begin{matrix}{\hat{x}}_{m} ( k - d ) = {\sum }_{n = 1}^{N} {\sum }_{i = 0}^{FF - 1} {f}_{m , n}^{T} {r}_{n} ( k - i ) - \\ {\sum }_{{m}^{′} = 1}^{M} {\sum }_{j = 1}^{Fb} {b}_{m , {m}^{′}} ( j ) {x}_{m} ( k - d - j ) - \\ {\sum }_{{m}^{′} = 1}^{M} {\sum }_{q = 1}^{d} {b}_{m , {m}^{′}} ( - q ) {x}_{m} ( k - d + q )\end{matrix}$$

where all the received spatial signals are utilized, and the feedback will subtract out all potential cross-couplings between transmitters (past and future). We now solve,

$${c}_{opt} = arg {min}_{c} E \{ {‖ x ( k - d ) - {c}^{H} g ‖}^{2} \} \qquad ( 1.14 )$$

where we have defined,

$$\begin{matrix}x ( k - d ) {=}^{Δ} [ \begin{matrix}{x}_{1} ( k - d ) \\ ⋮ \\ {x}_{M} ( k - d )\end{matrix} ] , \\ g {=}^{Δ} [ \begin{matrix}r \\ \tilde{x}\end{matrix} ] , \\ c {=}^{Δ} [ \begin{matrix}F \\ - B\end{matrix} ] \\ r = [ \begin{matrix}{r}_{1} \\ ⋮ \\ {r}_{N}\end{matrix} ] , \\ \tilde{x} = [ \begin{matrix}{\tilde{x}}_{1} \\ ⋮ \\ {\tilde{x}}_{M}\end{matrix} ] , \\ F = [ \begin{matrix}{f}_{1 , 1} & ⋯ & {f}_{M , 1} \\ ⋮ & & ⋮ \\ {f}_{1 , N} & ⋯ & {f}_{M , N}\end{matrix} ] , \\ B = [ \begin{matrix}{b}_{1 , 1} & ⋯ & {b}_{M , 1} \\ ⋮ & & ⋮ \\ {b}_{1 , M} & ⋯ & {b}_{M , M}\end{matrix} ] \\ {r}_{n} = {[ {{r}_{n} ( k )}^{T} , {{r}_{n} ( k - 1 )}^{T} , … , {{r}_{n} ( k - FF + 1 )}^{T} ]}^{T} \\ {\tilde{x}}_{m} = [ {x}_{m} ( k ) , … , {x}_{m} ( k - d + 1 ) , {x}_{m} ( k - d - 1 ) , … , \\ { {x}_{m} ( k - d - FB ) ]}^{T}\end{matrix} \qquad ( 1.15 )$$

The solution is again obtained from the Orthogonality Principle,

$$\begin{matrix}B = \frac{1}{{σ}_{x}^{2}} {X}^{H} F \\ F = {( Ω - \frac{1}{{σ}_{x}^{2}} {XX}^{H} )}^{- 1} Θ\end{matrix} \qquad ( 1.16 )$$

where we defined,
ΩΔσₓ²Γ(H)Γ(H)+σₓ²Rₚ, ΦΔ=σₓ²I_{M(FB+d)} (1.17)

$$\begin{matrix}X {=}^{Δ} [ \begin{matrix}{X}_{1 , 1} & ⋯ & {X}_{1 , M} \\ ⋮ & & ⋮ \\ {X}_{N , 1} & ⋯ & {X}_{N , M}\end{matrix} ] & ( 1.18 ) \\ {X}_{n , m} = {σ}_{x}^{2} [ \begin{matrix}{h}_{n , m} ( 0 ) & {h}_{n , m} ( 1 ) & ⋯ & {h}_{n , m} ( d - 1 ) & {h}_{n , m} ( d + 1 ) & ⋯ & {h}_{m , n} ( d + FB ) \\ 0 & {h}_{m , n} ( 0 ) & & ⋮ & {h}_{m , n} ( d ) & & {h}_{m , n} ( d + FB - 1 ) \\ ⋮ & ⋰ & ⋰ & ⋮ & ⋮ & & ⋮ \\ 0 & ⋯ & 0 & {h}_{m , n} ( 0 ) & {h}_{m , n} ( d - FF + 2 ) & ⋯ & {h}_{m , n} ( d + FB - FF + 1 )\end{matrix} ] & ( 1.19 ) \\ Θ {=}^{Δ} [ \begin{matrix}{φ}_{1 , 1} & ⋯ & {φ}_{1 , M} \\ ⋮ & & ⋮ \\ {φ}_{N , 1} & ⋯ & {φ}_{N , M}\end{matrix} ] , {φ}_{n , m} = {σ}_{x}^{2} Γ ( {h}_{n , m} ) {e}_{d} & ( 1.20 )\end{matrix}$$

where e_{d} is a vector with all zeros except for a single 1 in the dth position.

As with the embodiment of FIG. 1, the closed-form solution 1.16 may be computed directly, or alternatively the implementation may be used based on adaptive filtering (LMS, RLS, etc.), using unique training or pilot signals from the various transmit antennas such as described with respect to FIG. 2.

Transmit diversity systems use multiple transmit antennas and one or more receive antennas to send a single data stream (unlike MIMO). The transmit diversity scheme can be defined by an encoder and a decoder. For example, in UMTS the open loop transmit diversity scheme (STTD) with two antennas, two symbols at a time are encoded. The encoder sends [x₁,−x*₂] to antenna 1 and [x₂,x*₁] to antenna 2 in two consecutive time slots. The decoder then forms two combinations of the received signals, \hat{x}₁=h*₁r₁+h₂r*₂, and \hat{x}_{2=h*}₂r₁−h₁r*₂. This typical operation of transmit diversity assumes that the radio channel was not time-dispersive.

To correct for time-dispersion, it is possible to use the linear equalizer, as seen in FIG. 3. The system should have at least as many receive antennas as transmit antennas for good performance. The number of equalizer outputs will be equal to the number of transmit antennas. This linear equalizer is identical to the one described previously for MIMO systems.

FIG. 5 illustrates an embodiment of the receiver processing structure according to the present invention for a transmit diversity system. As shown, the receiver processing structure is the same as that illustrated in FIG. 3, except that the symbol estimator structures 150 shown in FIG. 3 have been replaced with a symbol estimation structure 160. Accordingly, only these differences will be described for the sake of brevity. As shown, the linear equalizer is followed by a transmit diversity decoder 162, and the symbol estimators 18. The symbols are then encoded by a transmit diversity encoder 164, giving a reconstituted chip stream. If other signals are also present in the downlink, they should also be reconstructed, and their chips summed together to give the total transmit streams. These are used in the feedback and feedforward filters 124 and 128, as described previously. At the output of the adders 130, a transmit diversity decoder may be used again, and receiver processing continues in the normal fashion (FEC decoding, etc.)

The invention being thus described, it will be obvious that the same may be varied in many ways. For example, while aspects of the present invention may have been described with respect to receiver processing of downlink CDMA signals, the present invention is equally applicable to the uplink if, for example, orthogonal uplink signals are sent. Such variations are not to be regarded as a departure from the spirit and scope of the invention, and all such modifications are intended to be included within the scope of the present invention.

1. A method for receiver processing of CDMA signals, comprising:
performing linear equalization on at least one received signal to generate at least one linear equalized signal;
despreading each linear equalized signal to generate one or more signal streams associated with each linear equalized signal;
estimating symbols in each signal stream to generate associated symbol estimate signal streams;
respreading the symbol estimate signal streams associated with each linear equalized signal to generate a composite signal associated with each linear equalized signal;
filtering each composite signal using a first filter;
filtering each received signal using a second filter complementing the first filter; and
combining associated output from the first and second filters to generate a processed received signal associated with each received signal.

2. The method of claim 1, wherein the estimating step performs a non-linear soft-decision estimation of symbols in each signal stream.

3. The method of claim 1, wherein
the filtering each composite signal step generates output representing an influence of at least past chips on a current chip in an associated received signal; and
the combiner subtracts output of the filtering each composite signal step from associated output of the filtering each received signal step.

4. The method of claim 3, wherein the filtering each composite signal step generates output representing an influence of past and future chips on a current chip in an associated received signal.

5. The method of claim 1, wherein
the filtering each composite signal step generates output representing an influence of at least future chips on a current chip in an associated received signal; and
the combiner subtracts output of the filtering each composite signal step from associated output of the filtering each received signal step.

6. The method of claim 1, wherein the filtering each composite signal and filtering each received signal steps perform filtering based on decision feedback equalization.

7. The method of claim 1, further comprising:
delaying each received signal prior to the filtering each received signal step.

8. The method of claim 7, wherein the delaying step delays each received signal by an amount of time associated with at least a processing time of the linear equalization step.

9. The method of claim 1, further comprising:
over-sampling at least one signal received over at least one antenna to generate the at least one received signal.

10. The method of claim 1, further comprising:
despreading each of the processed received signals.

11. The method of claim 1, further comprising:
generating filter taps for the first and second filters.

12. The method of claim 11, wherein the generating filter taps step adaptively generates the filter taps for the first and second filters.

13. The method of claim 12, wherein the generating filter taps step adaptively generates the filter taps for the first and second filters according to a least mean squares method.

14. The method of claim 12, wherein the generating filter taps step adaptively generates the filter taps for the first and second filters according to a recursive mean squares method.

15. The method of claim 12, wherein the generating filter taps step adaptively generates the filter taps for the first and second filters based on a past value of the filter taps and a past value of inputs to the first and second filters.

16. The method of claim 1, wherein the despreading step despreads each linear equalized signal into one or more data symbol streams.

17. The method of claim 1, wherein at least one received signal includes symbols for more than one user.

18. The method of claim 1, wherein each received signal is associated with a signal received by a different antenna.

19. A method for receiver processing of CDMA signals, comprising:
performing chip level linear equalization of at least one received signal;
estimating symbols in the at least one received signal;
performing first chip level filtering on output from the estimating step;
performing second chip level filtering on the received signal; and
combining output of the performing first and second chip level filtering steps.
